(19) United States
(12) Patent Application Publication
(10) Pub. No.: US 2011/0037676 A1
(43) Pub. Date: Feb. 17, 2011

(54) MOBILE RADIO DEVICE

(75) Inventors: Hiroaki Kobayashi, Miyagi (JP); Hideki Hayama, Kanagawa (JP); Shingo Sumi, Miyagi (JP); Akito Sakamoto, Kanagawa (JP)

Correspondence Address: Seed Intellectual Property Law Group PLLC, 701 Fifth Avenue, Suite 5400, Seattle, WA, 98104, US

(73) Assignee: PANASONIC CORPORATION, Osaka (JP)

(21) Appl. No.: 12/989,371

(22) PCT Filed: Apr. 20, 2009
(86) PCT No.: PCT/JP2009/001802

§ 371 Date: Oct. 22, 2010

(30) Foreign Application Priority Data
Apr. 25, 2008 (JP) 2008-115687

(51) Int. Cl. H01Q 21/28

(52) U.S. Cl. 343/853

(57) ABSTRACT

To make it possible to suppress degradation in characteristics by electromagnetic coupling between plurality of antennas and to cope with miniaturization of a housing even if a plurality of radio circuits operate simultaneously. In a mobile radio apparatus in which a circuit board 102, a first antenna 111 and a second antenna 112 are mounted in a housing 101, a first radio section 121 and a second radio section 122 are mounted in the circuit board 102 and the first radio section 121 and the second radio section 122 can operate simultaneously, a reactance element 131 for influencing an operating frequency of the first radio section 121 or the second radio section 122 is disposed in at least one of the first antenna 111 and the second antenna 112 when an electric length of the circuit board 102 is configured to be shorter than one-fourth a wavelength of at least one of the operating frequencies of the first radio section 121 and the second radio section 122.

### TECHNICAL FIELD

The present invention relates to a mobile radio apparatus for mounting a plurality of antennas and a plurality of radio circuits.

### BACKGROUND ART

For example, a mobile radio apparatus such as a mobile telephone terminal often has a radio function of receiving a digital broadcast (DTV) such as a television program broadcast as the so-called One Seg (trademark) broadcast in addition to a cellular radio communication function necessary to ensure a radio channel used in a call, packet communication, etc.

The mobile radio apparatus having such a digital broadcast receiving function requires an independent antenna for receiving the digital broadcast in addition to an antenna used in the cellular radio communication function. Also, a frequency band of the digital broadcast targeted for receiving is very wide, so that it is often difficult to receive all the digital broadcasts with sufficient quality by only a single antenna.

Incidentally, in the case of mounting a plurality of antennas on a miniature housing such as the mobile radio apparatus, the antennas interfere mutually by electromagnetic coupling when these antennas are closely arranged, so that performance of the respective antennas degrades. For example, when an antenna used for the cellular radio communication function and an antenna used for the digital broadcast receiving function are mutually closely arranged in the case of mounting the cellular radio communication function and the digital broadcast receiving function in the mobile radio apparatus, electromagnetic coupling occurs between the two antennas and antenna gain of each of the antennas tends to reduce.

A technique for preventing electromagnetic coupling between a plurality of antennas by grounding (terminating) the nonselective antenna when one radio circuit selectively uses the plurality of antennas independent from one another is disclosed in Patent literature 1.

Also, a technique for disposing a foldable housing and also arranging one of the plurality of antennas in a hinge section of the housing and arranging the other antenna in a position opposite to the hinge section of the housing and increasing a distance between the plurality of antennas is proposed in Patent literature 2.

### CITATION LIST

### Patent Literature

Patent literature 1: JP-A-7-297749

Patent literature 2: JP-A-2004-153589

### SUMMARY OF INVENTION

### Technical Problem

In the case of the mobile telephone terminal, switching to a state in which any one of a plurality of antennas cannot be used cannot be performed, because, for example, it is also necessary to consider a situation in which the cellular radio communication function and the digital broadcast receiving function are simultaneously used. Therefore, the technique of Patent literature 1 in which one of the antennas is grounded cannot be used.

Also, as disclosed in Patent literature 2, in the case of arranging each of the plurality of antennas in a place separate from another antenna, space with an sufficient size for arranging the respective antennas must be secured independently and thinning and miniaturization of the housing are obstructed. Also, even in the case of adopting the technique of Patent literature 2, it becomes difficult to secure a sufficient distance between the plurality of antennas when the thinning or miniaturization of the housing advances further.

The present invention has been implemented in view of the circumstances described above, and an object of the invention is to provide a mobile radio apparatus capable of coping with miniaturization of a housing while suppressing degradation in characteristics by electromagnetic coupling between a plurality of antennas even when a plurality of radio circuits operate simultaneously in the case of mounting the plurality of antennas and the plurality of radio circuits connected to the respective antennas on the housing limited in size.

### Technical Solution

The invention provides a mobile radio apparatus, comprising: a housing; a circuit board disposed inside the housing; a first radio circuit and a second radio circuit provided in the circuit board; a first antenna electrically connected to the first radio circuit; and a second antenna electrically connected to the second radio circuit, wherein the first radio circuit and the second radio circuit can operate simultaneously, an electric length of the circuit board is configured to be shorter than one-fourth a wavelength of at least one of an operating frequency of the first radio circuit and an operating frequency of the second radio circuit, and the mobile radio apparatus comprises a reactance element for influencing the operating frequency of the first radio circuit or the second radio circuit in at least one of the first antenna and the second antenna.

By the configuration described above, the reactance element is disposed in at least one of the first antenna and the second antenna and thereby, electromagnetic coupling between the plurality of antennas is suppressed even when the electric length of the circuit board is shorter than one-fourth the wavelength of at least one of the operating frequency of the first radio circuit and the operating frequency of the second radio circuit and the first antenna and the second antenna are closely arranged. Therefore, degradation in characteristics by the electromagnetic coupling between the plurality of antennas can be suppressed even when the plurality of antennas and the plurality of radio circuits connected to the respective antennas are mounted on the housing limited in size and the plurality of radio circuits operate simultaneously. Also, it is possible to cope with miniaturization of the housing. In the case of thinning and miniaturizing the mobile radio apparatus which simultaneously operates the plurality of radio circuits, interference between the plurality of antennas is suppressed and good performance can be obtained in each of the radio circuits.

The invention includes the configuration of the mobile radio apparatus, wherein the housing includes a first housing, a second housing and a hinge section for joining the first housing to the second housing in a relatively rotatable or movable state, the first housing includes a first circuit board separate from the circuit board, the second housing includes a second circuit board in which the first radio circuit and the second radio circuit are mounted as the circuit board, the first antenna is configured to include an antenna element body having a conductive member arranged in the first housing and an antenna intermediate having a conductive hinge member arranged in the hinge section, and the second antenna is arranged inside the second housing.

By the configuration described above, in a configuration of joining the plurality of housings by the hinge section and using the hinge member in a power feeding path of the antenna, the reactance element is disposed in at least one of the first antenna and the second antenna and thereby, the electromagnetic coupling between the plurality of antennas can be suppressed and the degradation in characteristics can be prevented.

The invention includes the configuration of the mobile radio apparatus, wherein the antenna intermediate includes a first hinge member and a second hinge member having mutually different rotating axes for rotating the first housing and the second housing as the hinge member, and the reactance element is arranged between the first hinge member and the second hinge member.

By the configuration described above, in the case of having the first hinge member and the second hinge member as the hinge member constructing a part of the first antenna, the reactance element is disposed between this first hinge member and the second hinge member and thereby, the electromagnetic coupling to the second antenna located in the vicinity of the hinge member can be suppressed and the degradation in characteristics can be prevented.

The invention includes the configuration of the mobile radio apparatus, wherein electrical connections between the antenna element body and the first hinge member, between the first hinge member and the reactance element, between the reactance element and the second hinge member, and between the second hinge member and the second circuit board are respectively made through connection conductors.

The invention includes the configuration of the mobile radio apparatus, wherein a second reactance element is arranged in the first circuit board, the first hinge member is electrically connected to a ground of the first circuit board through the second reactance element, the ground of the first circuit board is electrically connected to the antenna element body of the first antenna, and electrical connections between the second reactance element and the first hinge member, between the first hinge member and the reactance element, between the reactance element and the second hinge member, and between the second hinge member and the second circuit board are respectively made through connection conductors.

By the configuration described above, the reactance element is inserted and disposed in the hinge section in which the second hinge member and the first hinge member constructing a part of the first antenna are disposed, and also, this first hinge member is electrically connected to the ground of the first circuit board of the inside of the first housing through the second reactance element and thereby, the electromagnetic coupling to the second antenna located in the vicinity of the hinge member can be suppressed and the degradation in characteristics can be prevented.

The invention includes the configuration of the mobile radio apparatus, wherein the antenna intermediate includes a first hinge member and a second hinge member for rotating the first housing and the second housing in respectively different axial directions as the hinge member, the reactance element is arranged between the first hinge member and the first circuit board, and the first hinge member is electrically connected to a ground of the first circuit board through the reactance element, the ground of the first circuit board is electrically connected to the antenna element body of the first antenna, and electrical connections between the reactance element and the first hinge member, between the first hinge member and the second hinge member, and between the second hinge member and the second circuit board are respectively made through connection conductors.

By the configuration described above, the first hinge member constructing a part of the first antenna is electrically connected to the ground of the first circuit board of the inside of the first housing through the second reactance element and thereby, the electromagnetic coupling to the second antenna located in the vicinity of the hinge member can be suppressed and the degradation in characteristics can be prevented.

The invention includes the configuration of the mobile radio apparatus, wherein the antenna element body is directly, electrically connected to the first hinge member, and electrical connections between the first hinge member and the reactance element, between the reactance element and the second hinge member, and between the second hinge member and the second circuit board are respectively made through connection conductors.

The invention includes the configuration of the mobile radio apparatus, wherein the mobile radio apparatus includes a conductive connection member close to the first hinge member, and electrical connections between the antenna element body and the first hinge member, between the first hinge member and the connection member, between the connection member and the reactance element, between the reactance element and the second hinge member, and between the second hinge member and the second circuit board are respectively made through connection conductors.

The invention includes the configuration of the mobile radio apparatus, wherein the reactance element is a conductive pattern of a meander shape.

The invention includes the configuration of the mobile radio apparatus, wherein the reactance element is a conductive pattern of a winding shape (a helical shape).

### ADVANTAGEOUS EFFECTS OF INVENTION

According to the invention, a mobile radio apparatus capable of coping with miniaturization of a housing while suppressing degradation in characteristics by electromagnetic coupling between a plurality of antennas even when a plurality of radio circuits operate simultaneously in the case of mounting the plurality of antennas- and the plurality of radio circuits connected to the respective antennas on the housing limited in size can be provided.

### BRIEF DESCRIPTION OF DRAWINGS

FIG. 1 is a block diagram showing a configuration of a main section of a mobile radio apparatus according to a first embodiment of the invention.

FIG. 2 is a front view representing a configuration of a main section of a mobile radio apparatus according to a second embodiment of the invention.

FIG. 3 shows a relation between an operating frequency band of each of the radio circuits and its wavelength.

FIG. 4 is a front view representing a configuration of a main section of a mobile radio apparatus according to a first modified example of the second embodiment.

FIG. 5 is a front view representing a configuration of a main section of a mobile radio apparatus according to a second modified example of the second embodiment.

FIG. 6 is a front view representing a configuration of a main section of a mobile radio apparatus according to a third modified example of the second embodiment.

FIG. 7 is a front view representing a configuration of a main section of a mobile radio apparatus according to a fourth modified example of the second embodiment.

FIG. 8 is a front view representing a configuration of a main section of a mobile radio apparatus according to a fifth modified example of the second embodiment.

### DESCRIPTION OF EMBODIMENTS

The present embodiments show a configuration example of applying a mobile radio apparatus of the invention to a mobile telephone terminal etc. including a cellular radio communication function and a digital broadcast receiving function used in a mobile communication system such as a mobile telephone as one example of the mobile radio apparatus.

### First Embodiment

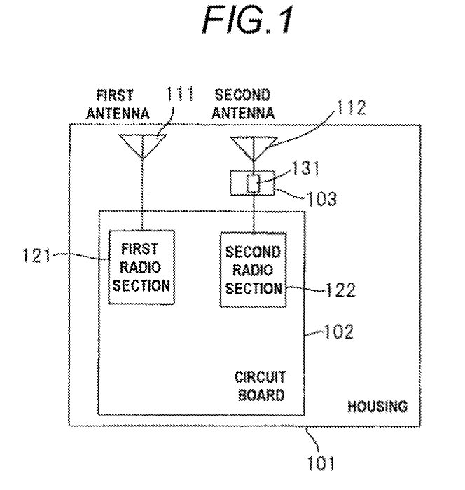

FIG. 1 is a block diagram showing a configuration of a main section of a mobile radio apparatus according to a first embodiment of the invention. The mobile radio apparatus of the embodiment is configured to mount a circuit board 102, a first antenna 111 as a first antenna and a second antenna 112 as a second antenna in a housing 101. Also, a circuit of a second radio section 122 as a second radio circuit and a circuit of a first radio section 121 as a first radio circuit independent mutually are mounted in the circuit board 102. Then, the first antenna 111 is connected to the first radio section 121 and the second antenna 112 is connected to the second radio section 122.

The first radio section 121 and the second radio section 122 use mutually close frequency bands though the operating frequency bands of them are different. For example, the case where the first radio section 121 operates so as to conduct communication at a cellular frequency band (a band of 800 MHz) for radio communication of the mobile telephone and the second radio section 122 operates so as to receive radio waves of a frequency band (473 to 770 MHz) of a digital broadcast (DTV) such as a television program broadcast as the so-called One Seg (trademark) broadcast is assumed actually. In addition to these frequency bands, it is also contemplated to use, for example, a cellular frequency band (bands of 1700 MHz and 2000 MHz), a frequency band (a band of 1500 MHz) of GPS (Global Positioning System) or a frequency band (a band of 2400 MHz) of Bluetooth (registered trademark).

In the mobile radio apparatus of the embodiment, the first radio section 121 operates using the first antenna 111 in order to send and receive a radio signal and the second radio section 122 operates using the second antenna 112 in order to receive the radio waves of the digital broadcast. Therefore, the first antenna 111 is electrically connected to an input end of the first radio section 121 and the second antenna 112 is electrically connected to an input end of the second radio section 122.

Here, when a distance between the first antenna 111 and the second antenna 112 is very close, for example, about one-twentieth or less the wavelength of an operating frequency band, interference occurs by electromagnetic coupling between the first antenna 111 and the second antenna 112, and antenna gain reduces. In this case, the operating frequency band (the band of 800 MHz) used by the first radio section 121 is mutually close to the operating frequency band (473 to 770 MHz) used by the second radio section 122, so that the electromagnetic coupling tends to occur. Further, when the operating frequency band is low, an electric length of the circuit board, that is, a size of the board cannot be increased sufficiently with respect to a use wavelength, so that the electromagnetic coupling tends to occur. In the case of the mobile telephone terminal etc., a size of the housing 101 is small, so that it is difficult to sufficiently separate the first antenna 111 from the second antenna 112.

For example, a dimension of a conductive body (for example, a ground pattern) on the circuit board 102 in which the first radio section 121 and the second radio section 122 are arranged shall satisfy a condition (L<λ·¼) that an electric length L of the dimension is shorter than one-fourth a wavelength λ of the frequency band (operating frequency band) of a radio signal handled by the first radio section 121 or the frequency band (operating frequency band) of a radio signal handled by the second radio section 122. That is, it is assumed that an operating frequency of the radio circuit is relatively low and a dimension of the circuit board 102 is small with respect to the wavelength of the operating frequency. In such a case, an antenna current goes into a flow over the whole conductive body on the circuit board 102 at the time of operation of the first radio section 121 and the second radio section 122. Therefore, the electromagnetic coupling between the first antenna 111 and the second antenna 112 increases, and interference between the mutual antennas increases.

Hence, in the embodiment, a reactance element for influencing the operating frequency of the first radio section 121 or the second radio section 122 as frequency adjusting means is disposed in at least one of the plurality of antennas. In an example of FIG. 1, it is configured to dispose a reactance element 131 in the second antenna 112 and the reactance element 131 is connected and inserted between the second antenna 112 and the input end of the second radio section 122 (in a position close to the antenna from a power feeding point or the antenna side from the input end). The reactance element 131 is an element such as a coil or a capacitor in which an impedance changes according to a frequency. Here, an element having electrical characteristics in which for the frequency band of the radio signal handled by the second radio section 122 and the second antenna 112, an influence is hardly exerted and the signal is passed as it is and for the frequency band of the radio signal handled by the close first radio section 121 and the first antenna 111, the impedance increases and passage of the signal is broken as frequency characteristics of the reactance element 131 is used. In brief, as seen from the first radio section 121 and the first antenna 111, by disposing the reactance element 131, an electric length of the second antenna 112 becomes short sufficiently with respect to the wavelength of the operating frequency band and the second antenna 112 hardly functions at the operating frequency of the first radio section 121. In the example of FIG. 1, in order to arrange the reactance element 131, a circuit board 103 is disposed, but the circuit board 103 can also be omitted.

By disposing the reactance element 131 in the second antenna 112, the first antenna 111 can be electrically separated from the second antenna 112. That is, by inserting the reactance element 131, a ground condition of the second antenna 112 changes and frequency characteristics change, so that an impedance of the second antenna 112 seen from the first radio section 121 or the first antenna 111 becomes very large at the operating frequency band of the first radio section 121. Therefore, by a difference between the impedances of the respective antennas at the operating frequency band of each of the radio sections, the electromagnetic coupling between the first antenna 111 and the second antenna 112 becomes unlikely occurred and an influence of the second antenna 112 on the first antenna 111 becomes small.

Alternatively, the reactance element may be disposed in the first antenna 111. Also, the reactance elements may be respectively inserted into both of a power feeding path of the first antenna 111 and a power feeding path of the second antenna 112. In the case of inserting the reactance elements into both power feeding paths, electromagnetic coupling between both power feeding paths can be suppressed by inserting the reactance elements with mutually different characteristics (impedances) into the respective power feeding paths.

According to the embodiment as described above, degradation in characteristics by the electromagnetic coupling between the plurality of antennas can be suppressed even when the plurality of radio circuits operate simultaneously by disposing the reactance element in the antenna in the mobile radio apparatus including the plurality of antennas. Also, even when a distance between the antennas cannot be secured sufficiently, an influence of the other antenna can be suppressed by the reactance element, so that it can also cope with a miniature apparatus and thinning and miniaturization of the housing can be achieved.

### Second Embodiment

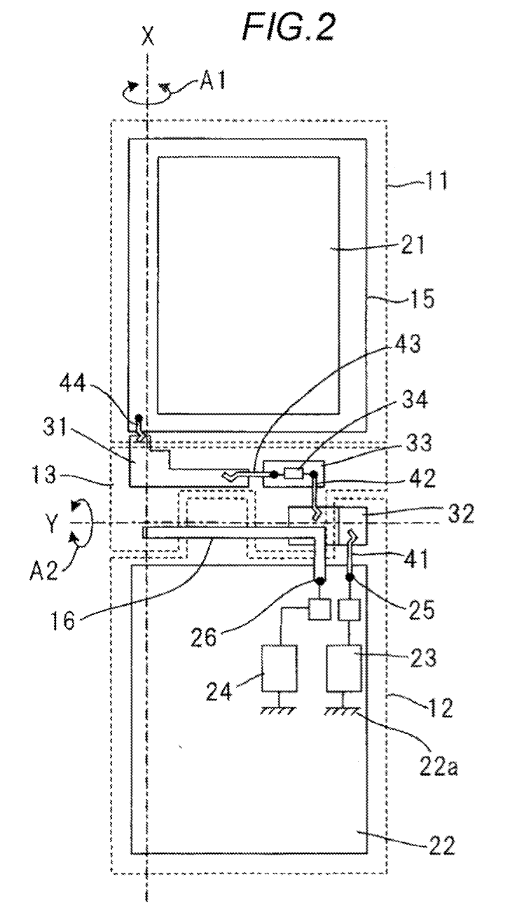

FIG. 2 is a front view representing a configuration of a main section of a mobile radio apparatus according to a second embodiment of the invention. The second embodiment is a configuration example capable of being applied to a mobile telephone terminal including a foldable housing. The housing of the mobile radio apparatus of the second embodiment is configured to have an upper housing 11 as a first housing, a lower housing 12 as a second housing and a relatively small intermediate housing 13 as a hinge section disposed in a joint of their upper and lower housings. The upper housing 11 and the lower housing 12 can be used in a longitudinally opened state of opening and closing by rotating in one side of a short side hand and a transversely opened state of opening and closing by rotating in one side of a long side hand.

A first hinge member 31 as a first hinge member and a second hinge member 32 as a second hinge member are disposed inside the intermediate housing 13. The first hinge member 31 joins the lower housing 12 and the intermediate housing 13 to the upper housing 11 in a state capable of relatively rotating in a direction of arrow A1 around a position of the axis shown by X in FIG. 2. Also, the second hinge member 32 joins the lower housing 12 to the intermediate housing 13 and the upper housing 11 in a state capable of relatively rotating in a direction of arrow A2 around a position of the axis shown by Y in FIG. 2. That is, the upper housing 11 is joined and supported to the lower housing 12 through the intermediate housing 13.

Therefore, the housing of the mobile radio apparatus is configured to have degrees of freedom of the two axes and be deformable. For example, when the housing is rotated in the direction of arrow A2 around the axis Y in FIG. 2, this housing is folded in a longitudinal direction and can be set in a state in which the upper housing 11 overlaps with the lower housing 12. Also, when the housing is rotated in the opposite direction, the housing is opened and can be set in an elongated shape in which a short side of the lower end of the upper housing 11 is mutually close to a short side of the upper end of the lower housing 12 with the short sides sandwiching the intermediate housing 13, in brief, in the longitudinally opened state as shown in FIG. 2.

Also, for example, by rotating the upper housing 11 with respect to the intermediate housing 13 in the direction of arrow A1 around the axis X in FIG. 2 in a state in which the upper housing 11 overlaps with the lower housing 12, the upper housing 11 can be opened with respect to the lower housing 12 in a state in which a long side of the left end of the lower housing 12 is close to a long side of the left end of the upper housing 11, and the housing can be set in the transversely opened state. Therefore, this housing can be used in three kinds of all of the longitudinally opened state, the transversely opened state and the closed state.

Then, a first circuit board 21 as a first circuit board is disposed in the upper housing 11 and a second circuit board 22 as a second circuit board is disposed in the lower housing 12. Like the case of a general mobile telephone terminal, a liquid crystal display and an electrical circuit related to its display are mounted in the upper housing 11 and these components are arranged on the first circuit board 21. Also, an operation section, various electrical circuits including a radio section, a controller, etc. are mounted in the lower housing 12 and these components are arranged on the second circuit board 22. The first circuit board 21 is mutually connected to the second circuit board 22 through a flexible electrical cable and a necessary signal line, a grounding line, a power source line, etc. of the first circuit board 21 are electrically connected to the second circuit board 22 by this electrical cable and this is not shown in FIG. 2.

The mobile radio apparatus of the embodiment mounts a digital broadcast receiving function for receiving a digital broadcast (DTV) and a cellular radio communication function used for obtaining a communication channel for packet communication, a voice call, etc. as a radio function.

A first radio circuit 23 as a first radio circuit and a second radio circuit 24 as a second radio circuit are arranged in the second circuit board 22. The first radio circuit 23 is a processing circuit for digital broadcast receiving, and performs receiving processing of a radio signal of a frequency band used in the digital broadcast. Also, the second radio circuit 24 is a processing circuit for the cellular radio communication function, and performs receiving processing and sending processing of a radio signal of a frequency band used in cellular communication. Here, the frequency band of 473 to 770 MHz shall be used in digital broadcast receiving and the frequency band of a band of 800 MHz (830 to 885 MHz) shall be used in cellular radio communication.

In addition, a band of 1700 MHz and a band of 2000 MHz may be used as the frequency band used in the cellular radio communication, and also in the case of the mobile telephone terminal, for example, a GPS (Global Positioning System) receiving function or a Bluetooth (registered trademark) communication function may be mounted in addition to the cellular radio communication function and the digital broadcast receiving function. In the case of using the GPS function, a frequency band of 1500 MHz is used and in the case of using the Bluetooth (registered trademark) function, a frequency band of 2400 MHz is used.

The mobile radio apparatus of the embodiment includes a second antenna element 16 constructing a monopole antenna as a second antenna used by the second radio circuit 24 for the cellular radio communication function. This second antenna element 16 is arranged in the upper end of the lower housing 12 opposite to the second hinge member 32 in the inside of the lower housing 12.

Also, a housing dipole antenna for operating as an antenna using the housing itself is constructed as a first antenna used by the first radio circuit 23 for the digital broadcast receiving function. A first antenna element 15 which is a component of the first antenna is constructed of a conductive member such as a conductive metal frame having the same size and shape as those of the upper housing 11, and is arranged in the upper housing 11 so as to function as one element of the housing dipole antenna. Also, a ground pattern of the second circuit board 22 having the same size and shape as those of the lower housing 12 and arranged in the lower housing 12 functions as the other element of the housing dipole antenna.

Also, a housing configuration deformable by the hinge member etc. is adopted, so that various components are disposed in order to electrically connect the first antenna element 15 of the upper housing 11 to a connection 25 of the first radio circuit 23 on the second circuit board 22 of the lower housing 12.

The first hinge member 31 for joining the upper housing 11 to the intermediate housing 13 is constructed of a conductive metal member, and functions as a part of a power feeding path of the first antenna. Also, the second hinge member 32 for joining the intermediate housing 13 to the lower housing 12 is similarly constructed of a conductive metal member, and functions as a part of the power feeding path of the first antenna. Further, a connection conductor 41 made of an elastically deformable elongated conductive member is disposed between the second hinge member 32 and the connection 25 which is an input terminal of the first radio circuit 23. One end of this connection conductor 41 is connected and fixed to the connection 25 and the other end conducts in contact with the second hinge member 32 and the connection conductor 41 electrically connects the connection 25 to the second hinge member 32. Also, a connection conductor 44 made of an elastically deformable elongated conductive member is disposed between the first hinge member 31 and the first antenna element 15. One end of the connection conductor 44 is connected and fixed to the first antenna element 15 and the other end conducts in contact with the first hinge member 31 and the connection conductor 44 electrically connects the first antenna element 15 to the first hinge member 31.

Also, inside the intermediate housing 13, a connection board 33 is disposed between the first hinge member 31 and the second hinge member 32, and a reactance element 34 is mounted and arranged on this connection board 33. A connection conductor 43 made of an elastically deformable elongated conductive member is disposed between the first hinge member 31 and the connection board 33. One end of the connection conductor 43 is connected and fixed to one end of the reactance element 34 of the connection board 33 and the other end conducts in contact with the first hinge member 31 and the connection conductor 43 electrically connects the first hinge member 31 to the reactance element 34. Also, a connection conductor 42 made of an elastically deformable elongated conductive member is disposed between the second hinge member 32 and the connection board 33. One end of the connection conductor 42 is connected and fixed to the other end of the reactance element 34 of the connection board 33 and the other end conducts in contact with the second hinge member 32 and the connection conductor 42 electrically connects the second hinge member 32 to the reactance element 34.

Here, the first antenna element 15 disposed in the upper housing 11 functions as an antenna element body of the first antenna, and a hinge section etc. including the first hinge member 31 and the second hinge member 32 disposed in the intermediate housing 13 function as an antenna intermediate of the first antenna.

In the embodiment, the portion ranging from the antenna element to the near side of the input terminal of the radio circuit, including the power feeding path or various circuit elements disposed therebetween, as well as the antenna element itself is regarded as the antenna. Hence, the reactance element 34 is arranged in the power feeding path ranging to the first antenna element 15 and is configured to be disposed in the first antenna.

In the configuration of the embodiment, a distance between a power feeding section 26 (a power feeding section of the second antenna) which is a point of connection between the second radio circuit 24 and the second antenna element 16 and the connection 25 (a connection of the first antenna) between the first radio circuit 23 and the first antenna element 15 is very close, and becomes, for example, one-twentieth or less the wavelength of an operating frequency band. As a result of this, electromagnetic coupling tends to occur between the first antenna by the first antenna element 15 and the second antenna by the second antenna element 16 and interference tends to occur.

Here, an electric length. L of a dimension of a conductive body (for example, a ground pattern formed by metal foil) 22a on the second circuit board 22 in which the first radio circuit 23 and the second radio circuit 24 are arranged shall satisfy a condition of (L<λ1·¼) or (L<λ2·¼) with respect to a wavelength λ1 of a frequency band (operating frequency band) of a radio signal handled by the first radio circuit 23 or a wavelength λ2 of a frequency band (operating frequency band) of a radio signal handled by the second radio circuit 24. That is, a configuration in which the housing of the mobile radio apparatus is miniature and an operating frequency of the radio circuit is relatively low and a dimension of a circuit board 102 is small with respect to the wavelength of the operating frequency is assumed. In such a case, an antenna current goes into a flow over the whole conductive body on the second circuit board 22 at the time of operation of the first radio circuit 23 and the second radio circuit 24. Therefore, the electromagnetic coupling between the first antenna and the second antenna increases, and interference between the mutual antennas increases.

Hence, in the embodiment, the reactance element 34 is inserted into the first antenna (on the way to the power feeding path of the first antenna element 15) in order to suppress the electromagnetic coupling between the first antenna and the second antenna. This reactance element 34 is an element constructed of, for example, a coil or a capacitor and is the element in which an impedance changes according to a frequency. Concretely, the reactance element 34 has characteristics in which, for a signal of the frequency band (473 to 770 MHz) received by the first radio circuit 23, the impedance is small and the signal is passed as it is and, for a signal of the frequency band (830 to 885 MHz) sent and received by the second radio circuit 24, the impedance is large and passage of the signal is blocked.

Also, in the configuration example of FIG. 2, electromagnetic coupling tends to occur between the second antenna element 16 and the first hinge member 31 arranged in mutually close positions by a size, a shape, an arrangement position, etc. of the first hinge member 31 present in the power feeding path to the first antenna element 15. Hence, by inserting the reactance element 34 between the first hinge member 31 and the second hinge member 32 on the way to the power feeding path to the first antenna element 15, impedances of the respective antennas at the operating frequency band of each of the radio circuits are varied and the electromagnetic coupling between the second antenna element 16 and the first hinge member 31 is suppressed. In this case, the impedance at the time of seeing the first antenna element 15 and the first hinge member 31 from the second antenna element 16 at the operating frequency band of the second radio circuit 24 becomes very large and the electromagnetic coupling between the first antenna and the second antenna can be made difficult to cause.

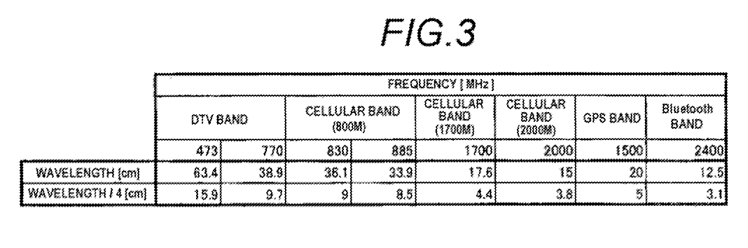

FIG. 3 shows a relation between an operating frequency band of each of the radio circuits and its wavelength. For example, a wavelength λ1 of the operating frequency band (a DTV band: 473 to 770 MHz) of the first radio circuit 23 is 63.4 to 38.9 cm, and λ1·¼ is equal to 15.9 to 9.7 cm. Also, a wavelength 72 at the operating frequency band (a cellular band: 830 to 885 MHz) of the second radio circuit 24 is 36.1 to 33.9 cm, and λ2·¼ is equal to 9 to 8.5 cm. Here, a physical length of the second circuit board 22 shown in FIG. 2 is about 9 cm, and the electric length of the conductive body on the second circuit board 22 shall be also formed so as to become about 9 cm. In this case, the condition of (L<λ1·¼) is satisfied and the antenna current goes into a flow over the whole second circuit board 22 at the time of operation of the first radio circuit 23, so that the electromagnetic coupling between the first antenna and the second antenna increases. On the other hand, in the embodiment, an influence of both antennas is suppressed by disposing the reactance element 34 in the first antenna. The configuration of the embodiment is particularly effective in the case of using one antenna and radio circuit in the DTV band and using the other antenna and radio circuit in the cellular band (bands of 800 MHz, 1700 MHz and 2000 MHz), the GPS band (a band of 1500 MHz), the Bluetooth (registered trademark) band (a band of 2400 MHz), etc. when the plurality of antennas and radio circuits are mounted as shown in FIG. 3.

In the embodiment as described above, degradation in characteristics by the electromagnetic coupling between the plurality of antennas can be suppressed even when the plurality of radio circuits operate simultaneously by disposing the reactance element 34 in one antenna, that is, the power feeding path to the first antenna element 15 in the mobile radio apparatus including the plurality of antennas. Hence, the function (digital broadcast receiving function) of the first radio circuit 23 and the function (cellular communication function) of the second radio circuit 24 can be used simultaneously and in this case, the electromagnetic coupling between the first antenna and the second antenna can be prevented. Also, even when a distance between the antennas cannot be secured sufficiently in the case where the housing is small and the electric length L of the conductive body of the circuit board is short with respect to the wavelength λ of the operating frequency of the radio circuit (L<λ·¼), an influence of the other antenna can be suppressed by the reactance element 34. Hence, even in an environment in which the electromagnetic coupling tends to occur, for example, a state of arranging the two antennas in the housing small in size with the antennas close mutually or a state of functioning as the antenna using the housing and arranging the other antenna of the inside of the housing, a situation in which the mutual antennas interfere and antenna gain reduces can be suppressed. Further, as described above, the embodiment can also cope with a miniature apparatus and the plurality of antennas can also be arranged in a state of being brought close mutually at a distance of about one-twentieth or less the wavelength of the operating frequency band, so that thinning and miniaturization of the housing are not obstructed.

In the configuration example shown in FIG. 2, the reactance element 34 is arranged on the way to the power feeding path of the first antenna element 15, but instead, the reactance element may be arranged in the power feeding path of the second antenna element 16. Also, the reactance elements may be disposed in both of the power feeding path of the first antenna element 15 and the power feeding path of the second antenna element 16 and in that case, it is necessary to arrange the reactance elements with mutually different frequency characteristics in the respective power feeding paths.

Next, several modified examples are shown in the configuration of the mobile radio apparatus of the second embodiment.

### First Modified Example

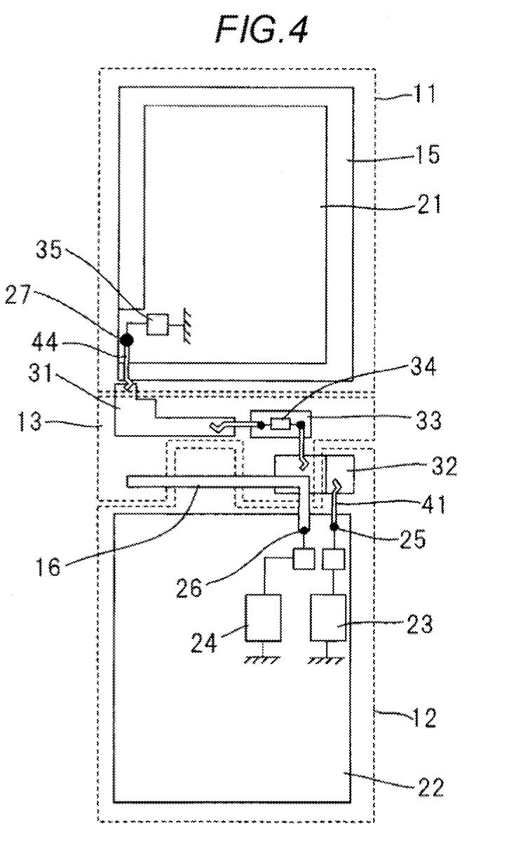

FIG. 4 is a front view representing a configuration of a main section of a mobile radio apparatus according to a first modified example of the second embodiment. In the first modified example, a reactance element 35 as a second reactance element is disposed in a first circuit board 21 and a first hinge member 31 is electrically connected to a ground of the first circuit board 21 through a connection conductor 44, a connection 27 and the reactance element 35, and the ground of the first circuit board 21 is electrically connected to a first antenna element 15. Here, one end of the reactance element 35 is connected to the connection conductor 44 through the connection 27 and the other end is connected to a ground pattern of the first circuit board 21 and is grounded. The other configuration is similar to that of the second embodiment shown in FIG. 2.

In this first modified example, the reactance element 35 in addition to a reactance element 34 is further disposed in a power feeding path of the first antenna element 15. Like the reactance element 34, the reactance element 35 has characteristics in which, for a signal of a frequency band (473 to 770 MHz) received by a first radio circuit 23, an impedance is small and the signal is passed as it is and, for a signal of a frequency band (830 to 885 MHz) sent and received by a second radio circuit 24, the impedance is large and passage of the signal is blocked. Therefore, by disposing the reactance element 34 and the reactance element 35 in two different places of the power feeding path of the first antenna, electromagnetic coupling between the first antenna and a second antenna can be adjusted more finely and can be suppressed further and an influence of the first antenna on the second antenna can be made smaller.

### Second Modified Example

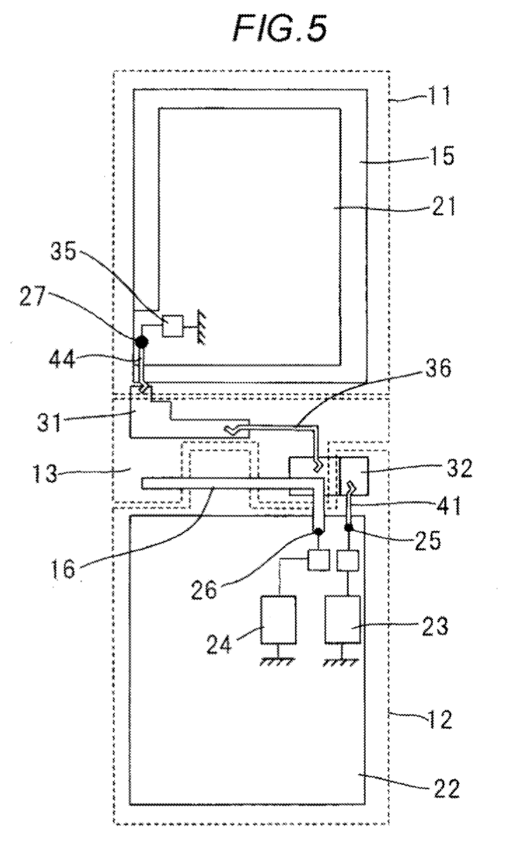

FIG. 5 is a front view representing a configuration of a main section of a mobile radio apparatus according to a second modified example of the second embodiment. In the second modified example, like the first modified example shown in FIG. 4, a reactance element 35 is disposed and a reactance element 34 of the second embodiment shown in FIG. 2 is configured to be omitted. Here, a connection conductor 36 made of an elastically deformable elongated conductive member is disposed between a second hinge member 32 and a first hinge member 31, and the second hinge member 32 is electrically connected to the first hinge member 31 through this connection conductor 36. Since the reactance element 34 is not disposed, a connection board 33 is also not disposed and is omitted. Frequency characteristics of the reactance element 35 are similar to those of the reactance element 34 of the first modified example and the second embodiment. The other configuration is similar to that of the second embodiment shown in FIG. 2.

In this second modified example, arrangement space of the connection board 33 and the reactance element 34 can be omitted in a hinge section in which an intermediate housing 13 is present, so that action and effect similar to those of the second embodiment or the first modified example can be obtained and also further thinning of a housing can be achieved.

### Third Modified Example

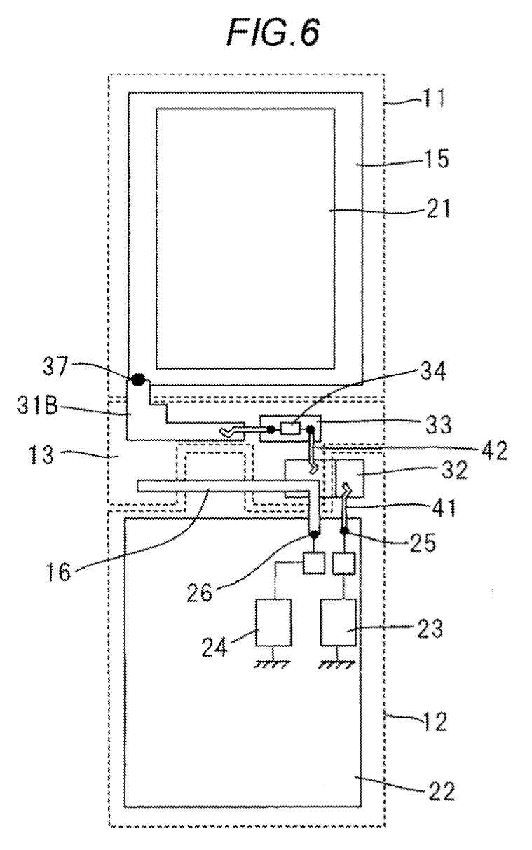

FIG. 6 is a front view representing a configuration of a main section of a mobile radio apparatus according to a third modified example of the second embodiment. The third modified example is configured to be omitted without disposing a connection conductor 44 of the second embodiment shown in FIG. 2. Here, one end of a first hinge member 31B is directly electrically connected to a first antenna element 15 of an upper housing 11 in a connection 37. The other configuration is similar to that of the second embodiment shown in FIG. 2.

### Fourth Modified Example

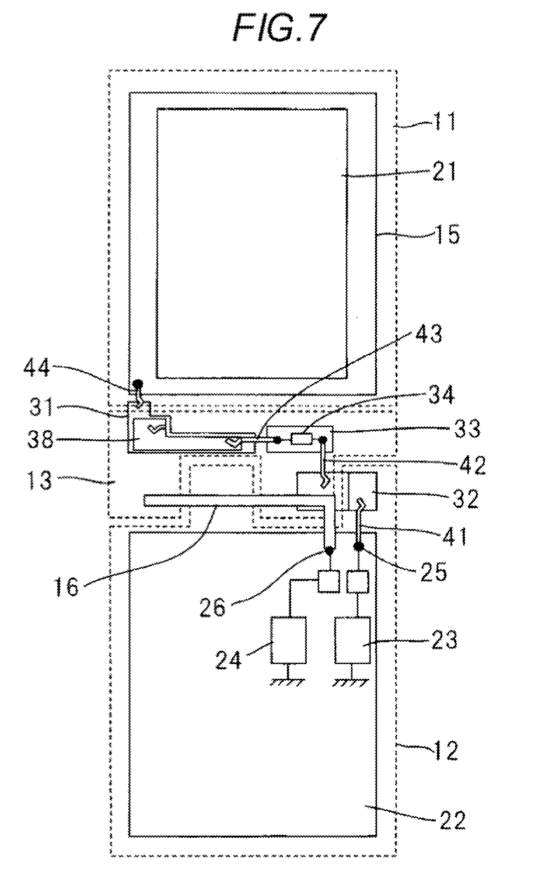

FIG. 7 is a front view representing a configuration of a main section of a mobile radio apparatus according to a fourth modified example of the second embodiment. The fourth modified example is configured to arrange a connection conductor 38 as a connection member made of a conductive member in proximity to a first hinge member 31 and make electrical connection through the connection conductor 38. Here, one end of a connection conductor 43 is connected and fixed to one end of a reactance element 34 of a connection board 33 and the other end conducts in contact with the connection conductor 38. Then, the connection conductor 38 conducts in contact with the first hinge member 31 and is electrically connected to the first hinge member 31. In brief, a power feeding path of a first antenna element is connected from a connection 25 to the first antenna element 15 through a connection conductor 41, a second hinge member 32, a connection conductor 42, the reactance element 34, the connection conductor 43, the connection conductor 38, the first hinge member 31 and a connection conductor 44. The other configuration is similar to that of the second embodiment shown in FIG. 2.

### Fifth Modified Example

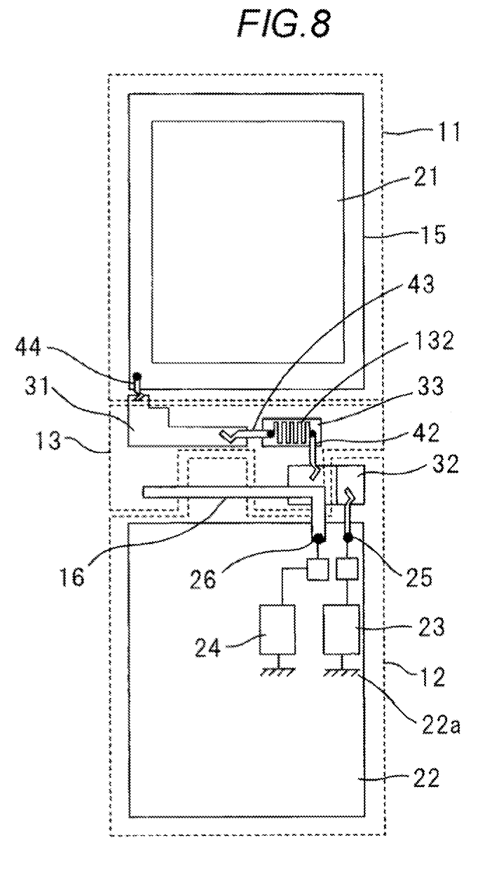

FIG. 8 is a front view representing a configuration of a main section of a mobile radio apparatus according to a fifth modified example of the second embodiment. In the fifth modified example, a reactance element 34 of the second embodiment shown in FIG. 2 is constructed by a conductive pattern of a meander shape (zigzag shape). Hereinafter, the conductive pattern constructing this reactance element is called a meander pattern 132. Here, inside an intermediate housing 13, a connection board 33 is disposed between a first hinge member 31 and a second hinge member 32, and the meander pattern 132 is arranged on this connection board 33. A connection conductor 43 made of an elastically deformable elongated conductive member is disposed between the first hinge member 31 and the Connection board 33. One end of this connection conductor 43 is connected and fixed to one end of the meander pattern 132 of the connection board 33 and the other end conducts in contact with the first hinge member 31 and the connection conductor 43 electrically connects the first hinge member 31 to the meander pattern 132. Also, a connection conductor 42 made of an elastically deformable elongated conductive member is disposed between the second hinge member 32 and the connection board 33. One end of this connection conductor 42 is connected and fixed to the other end of the meander pattern 132 of the connection board 33 and the other end conducts in contact with the second hinge member 32 and the connection conductor 42 electrically connects the second hinge member 32 to the meander pattern 132. The other configuration is similar to that of the second embodiment shown in FIG. 2. In addition, by constructing the reactance element 34 of the meander pattern 132 instead of a chip coil etc. as shown in the present configuration example, advantages that loss of insertion is small and antenna efficiency is high can be obtained or cost can be reduced by a reduction in the number of components. Also, shapes, for example, a folding back width or the number of folds of the meander pattern 132 can be set arbitrarily according to frequency or impedance matching conditions.

Also, the reactance element 34 is constructed of the meander pattern 132, but a helical pattern like a winding shape may be used. In that case, the helical pattern can be implemented by constructing the connection board 33 of a multilayer board.

In addition, in the fifth modified example of the second embodiment, the conductive pattern is described as the meander shape or the helical pattern, but a conductor of any shape may be used as long as a configuration capable of electrically connecting the connection conductor 42 to the connection conductor 43 is used.

In addition, in the embodiments described above, the case of applying the invention to the mobile telephone terminal for mounting the cellular communication function and the digital broadcast receiving function is assumed, but in addition to this case, a mobile radio apparatus for mounting a plurality of radio circuits using any radio waves of plural frequency bands close mutually and closely arranging antennas connected to the respective radio circuits can be applied similarly. Also, in the configuration example etc. of the second embodiment, the example of using the housing dipole antenna as one antenna is shown, but a configuration of using antennas of other forms can be applied similarly.

In addition, the invention is not limited to the case shown in the embodiments described above, and the invention intends to make change and application by persons skilled in the art based on well-known techniques and the mention of the description, and the change and application are included in the scope of protection.

The present application is based on Japanese patent application (Patent Application No. 2008-115687) filed on Apr. 25, 2008, and the contents of the patent application are hereby incorporated by reference.

### INDUSTRIAL APPLICABILITY

The invention has an effect capable of coping with miniaturization of a housing while suppressing degradation in characteristics by electromagnetic coupling between plurality of antennas even when plurality of radio circuits operate simultaneously in the case of mounting the plurality of antennas and the plurality of radio circuits connected to the respective antennas on the housing limited in size, and is useful as a mobile radio apparatus etc. for mounting the plurality of antennas and the plurality of radio circuits, capable of being applied to, for example, a mobile telephone terminal.

### REFERENCE SIGNS LIST

11 UPPER HOUSING
12 LOWER HOUSING
13 INTERMEDIATE HOUSING
15 FIRST ANTENNA ELEMENT
16 SECOND ANTENNA ELEMENT
21 FIRST CIRCUIT BOARD
22 SECOND CIRCUIT BOARD
23 FIRST RADIO CIRCUIT
24 SECOND RADIO CIRCUIT
25 CONNECTION
26 POWER FEEDING SECTION
27,37 CONNECTION
31,31B FIRST HINGE MEMBER
32 SECOND HINGE MEMBER
33 CONNECTION BOARD
34,35 REACTANCE ELEMENT
36,38,41,42,43,44 CONNECTION CONDUCTOR
101 HOUSING
102 CIRCUIT BOARD
103 CIRCUIT BOARD
111 FIRST ANTENNA
112 SECOND ANTENNA
121 FIRST RADIO SECTION
122 SECOND RADIO SECTION
131 REACTANCE ELEMENT
132 MEANDER PATTERN

1. A mobile radio apparatus, comprising:
a first housing including a first circuit board;
a second housing including a second circuit board in which a first radio circuit and a second radio circuit which are operable simultaneously are mounted, an electric length of the second circuit board being configured to be shorter than one-fourth a wavelength of at least one of an operating frequency of the first radio circuit and an operating frequency of the second radio circuit;
a hinge section for joining the first housing to the second housing in a relatively rotatable or movable state;
a first antenna electrically connected to the first radio circuit, and being configured to include an antenna element body having a conductive member arranged in the first housing and an antenna intermediate having a conductive hinge member arranged in the hinge section;
a second antenna electrically connected to the second radio circuit, and arranged inside the second housing;
a reactance element for influencing the operating frequency of the first radio circuit or the second radio circuit, provided in at least one of the first antenna and the second antenna, wherein
the antenna intermediate includes a first hinge member and a second hinge member having mutually different rotating axes for rotating the first housing and the second housing as the hinge section, and
the reactance element is arranged between the first hinge member and the second hinge member.

2. (canceled)

3. (canceled)

4. The mobile radio apparatus as claimed in claim 1, wherein
electrical connections between the antenna element body and the first hinge member, between the first hinge member and the reactance element, between the reactance element and the second hinge member, and between the second hinge member and the second circuit board are respectively made through connection conductors.

5. The mobile radio apparatus as claimed in claim 1, wherein
a second reactance element is arranged in the first circuit board,
the first hinge member is electrically connected to a ground of the first circuit board through the second reactance element,
the ground of the first circuit board is electrically connected to the antenna element body of the first antenna, and
electrical connections between the second reactance element and the first hinge member, between the first hinge member and the reactance element, between the reactance element and the second hinge member, and between the second hinge member and the second circuit board are respectively made through connection conductors.

6. The mobile radio apparatus as claimed in claim 1, wherein
the antenna intermediate includes a first hinge member and a second hinge member for rotating the first housing and the second housing in respectively different axial directions as the hinge member,
the reactance element is arranged between the first hinge member and the first circuit board, and the first hinge member is electrically connected to a ground of the first circuit board through the reactance element,
the ground of the first circuit board is electrically connected to the antenna element body of the first antenna, and
electrical connections between the reactance element and the first hinge member, between the first hinge member and the second hinge member, and between the second hinge member and the second circuit board are respectively made through connection conductors.

7. The mobile radio apparatus as claimed in claim 1, wherein
the antenna element body is directly, electrically connected to the first hinge member, and electrical connections between the first hinge member and the reactance element, between the reactance element and the second hinge member, and between the second hinge member and the second circuit board are respectively made through connection conductors.

8. The mobile radio apparatus as claimed in claim 1, wherein
the mobile radio apparatus includes a conductive connection member close to the first hinge member, and
electrical connections between the antenna element body and the first hinge member, between the first hinge member and the connection member, between the connection member and the reactance element, between the reactance element and the second hinge member, and between the second hinge member and the second circuit board are respectively made through connection conductors.

9. The mobile radio apparatus as claimed in claim 1, wherein
the reactance element is a conductive pattern of a meander shape.

10. The mobile radio apparatus as claimed in claim 1, wherein
the reactance element is a conductive pattern of a winding shape.
